(19) United States
(12) Patent Application Publication
(10) Pub. No.: US 2026/0105403 A1
(43) Pub. Date: Apr. 16, 2026

(54) INSIGHTS TO IMPROVE A PROPERTY

(71) Applicant: STATE FARM MUTUAL AUTOMOBILE INSURANCE COMPANY, Bloomington, IL (US)

(72) Inventors: Amy L. Starr, Roswell, GA (US); Christopher Sawula, Decatur, GA (US); Aarsh Desai, Phoenix, AZ (US); Kahri Jung, Bloomington, IL (US); Briauna Dotson, San Jose, CA (US)

(21) Appl. No.: 19/020,186

(22) Filed: Jan. 14, 2025

Related U.S. Application Data
(60) Provisional application No. 63/707,376, filed on Oct. 15, 2024.

(51) Int. Cl. G06Q 10/0639; G06Q 50/16

(52) U.S. Cl. CPC G06Q 10/06393; G06Q 50/16

(57) ABSTRACT

The following relates generally to determining an insight to improve a property. In some embodiments, one or more processors are configured to: (i) build a profile based upon information of the property and/or information of a user; (ii) receive a list of insights; (iii) determine, based upon the profile, insight scores for respective insights of the list of insights; (iv) determine at least one insight to recommend based upon the insight scores; and/or (v) present, to the user, the determined at least one insight.

### CROSS REFERENCE TO RELATED APPLICATIONS

This application claims the benefit of U.S. Provisional Application No. 63/707,376, entitled “Insights to Improve a Property” (filed Oct. 15, 2024), the entirety of which is incorporated by reference herein.

### FIELD

The present disclosure generally relates to determining an insight to improve a property.

### BACKGROUND

A property owner may sometimes wonder what the most effective use of her time and/or money is to improve her property. For instance, even though she may be able to determine potential property improvement projects, it may be challenging to determine the answer to the question of which project most warrants the use of her time and/or money.

The systems and methods disclosed herein may provide solutions to these problems and may provide solutions to the ineffectiveness, insecurities, difficulties, inefficiencies, encumbrances, and/or other drawbacks of conventional techniques.

### SUMMARY

Broadly speaking, an app may provide insights (e.g., recommendations for projects, upgrades, etc.) to improve a property (e.g., a home). The insights may be based upon a geographic region of the property and/or personalized for a property owner. In addition to the insights, the property owner may be offered an insurance discount (e.g., a homeowners insurance discount), coupons for products (e.g., a coupon to purchase a product to complete an insight), and/or recommendations for contractors (e.g., a contractor to complete an insight). In addition, a user may be given rewards points for completing an insight. In addition, a home score (e.g., a property score) may be determined from subscores, such as a safety subscore, a structural subscore, a plumbing subscore, and/or a heating, ventilation, and air conditioning (HVAC) subscore. Completion of an insight may then increase the overall home score and/or any of the subscores.

In one aspect, a computer-implemented method for determining an insight to improve a property may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) building, via one or more processors, a profile based upon information of the property and/or information of a user; (2) receiving, via one or more processors, a list of insights; (3) determining, via the one or more processors, based upon the profile, insight scores for respective insights of the list of insights; (4) determining, via the one or more processors, at least one insight to recommend based upon the insight scores; and/or (5) presenting, via the one or more processors, to the user, the determined at least one insight. The method may include additional, fewer, or alternate actions, including those discussed elsewhere herein.

In another aspect, a computer device for determining an insight to improve a property may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) build a profile based upon information of the property and/or information of a user; (2) receive a list of insights; (3) determine, based upon the profile, insight scores for respective insights of the list of insights; (4) determine at least one insight to recommend based upon the insight scores; and/or (5) present, to the user, the determined at least one insight. The computer device may include additional, less, or alternate functionality, including that discussed elsewhere herein.

In yet another aspect, a computer system for determining an insight to improve a property may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) build a profile based upon information of the property and/or information of a user; (2) receive a list of insights; (3) determine, based upon the profile, insight scores for respective insights of the list of insights; (4) determine at least one insight to recommend based upon the insight scores; and/or (5) present, to the user, the determined at least one insight. The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary computer system for determining an insight to improve a property.

FIG. 2 depicts exemplary screens for presenting an insight for water heater maintenance.

FIG. 3 illustrates a flow diagram representing an exemplary computer-implemented method for determining an insight to improve a property.

FIG. 4 depicts an exemplary screen allowing entry of an answer for property information in the form of multiple choice entry.

FIG. 5 depicts an exemplary screen allowing entry of an answer for property information in the form of swipe entry.

FIG. 6 depicts an exemplary screen allowing entry of an indication of a smell.

FIG. 7 depicts an exemplary screen allowing entry of a seasonal preference.

FIG. 8 depicts an exemplary screen displaying an overall home score, a home safety subscore, and a fire protection subscore.

FIG. 9 depicts an exemplary screen listing plumbing insights, and further listing options to view categories and/or tags.

FIG. 10 depicts an exemplary screen including a tutorial explaining how to complete an insight.

FIG. 11 depicts a block diagram of an exemplary machine learning modeling method for training and evaluating exemplary machine learning model(s).

FIG. 12 depicts an exemplary home safety attribute.

FIG. 13 depicts exemplary matrix of smart smoke detectors indicating points that the smart smoke detectors may increase the home automation subscore by.

### DETAILED DESCRIPTION

The present embodiments relate to, inter alia, determining an insight to improve a property. Broadly speaking, a property owner may seek to determine the most effective way to spend his time and/or money to improve his property. To this end, systems and methods described herein may determine recommendations for insights (e.g., property improvement projects, etc.) to help the property owner make the determination.

Further regarding property ownership, the property owner may have property insurance (e.g., homeowners insurance, renters insurance, commercial insurance, umbrella insurance, etc.) through an insurance company. In this regard, the insurance company may provide, to the property owner, an application (app) that generates a home score. For example, an insurance company may provide an app to the property owner that determines a home score for his home. To this end, the insurance company may offer discounts on homeowners insurance based upon the home score, as well as discounts on items purchased through the app (e.g., items to complete home improvement projects, etc.). Moreover, the home score may include or be based upon subscores, such as a safety subscore (e.g., safety with regard to fire, weather hazards, crime, etc.), a structural subscore, a plumbing subscore, a heating, ventilation, and air conditioning (HVAC) subscore, etc. Such an app may provide recommendations to the homeowner for projects (e.g., “insights”) that will improve the home score, and may tailor the recommendations to maximize the impact of the homeowner's time and/or money.

### Exemplary Computer System

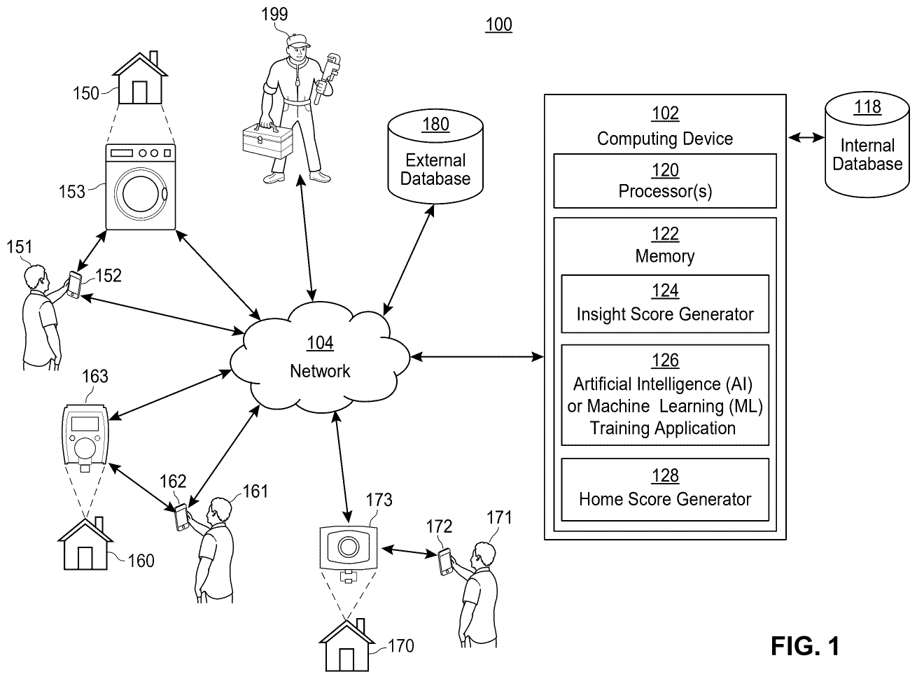

To this end, FIG. 1 illustrates an exemplary computer system 100 for determining an insight to improve a property in which the exemplary computer-implemented methods described herein may be implemented. The high-level architecture includes both hardware and software applications, as well as various data communications channels for communicating data between the various hardware and software components.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120 (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as insight score generator 124, artificial intelligence (AI) or machine learning (ML) training application 126, and/or home score generator 128.

In some examples, an insurance company owns the computing device 102, and the insurance company may provide insurance, such as homeowners or renters insurance, to the user 151. Such an insurance company may provide recommendations for insights (e.g., home improvement projects) to the user 151, 161, 171. Completing the insights may benefit both the user 151, 161, 171 and the insurance company. For example, if an insight to complete installing a sump pump is completed, it is less likely that the basement of the home 150, 160, 170 will flood, which benefits both the user 151, 161, 171 and the insurance company. In some such examples, the app may provide discounts on and/or recommendations for products and/or services to complete the insight. Additionally or alternatively, the app may provide discounts on insurance to reward the user for well maintaining their home 150, 160, 170.

Additionally or alternatively, it may be useful for the insurance company to generate a home score for the home 150. In some embodiments, the home score may be generated, at least in part, from sensor data from the home 150, 160, 170. Such sensor data may come from smart device(s) 153, 163, 173. In some such examples, completing an insight may improve the home score and/or any of the subscores. Furthermore, in some embodiments, a tutorial may be provided explaining how to complete the insight.

Any of the users 151, 161, 171 may use their respective user devices 152, 162, 172 to view the recommended insights, and/or home score(s) (e.g., via a display of the user device 152, 162, 172). The user devices 152, 162, 172 may be any suitable device, such as a computer, a mobile device, a smartphone, a laptop, a phablet, a chatbot or voice bot, etc. The user device 152, 162, 172 may include one or more display devices, one or more processors, one or more memories, etc.

The exemplary system 100 may also include external database 180 and internal database 118. Examples of the data stored by the external database 180 and/or internal database 118 include: historical information used to train AI and/or ML models and/or algorithms, such as historical insights, historical insights scores, historical profiles, historical home scores and/or subscores, historical questions (e.g., historical questions to determine information for the profile), etc. Further examples of the data stored by the external database 180 and/or internal database 118 include: current lists of insights; information of properties; information of users; weather information; etc.

In addition, further regarding the example system 100, the illustrated exemplary components may be configured to communicate, e.g., via a network 104 (which may be a wired or wireless network, such as the internet), with any other component. Furthermore, although the example system 100 illustrates certain number(s) of each of the components, any number of the example components are contemplated (e.g., any number of users, user devices, homes, smart devices, computing devices, databases, contractors, etc.).

### Exemplary Insight Presentation

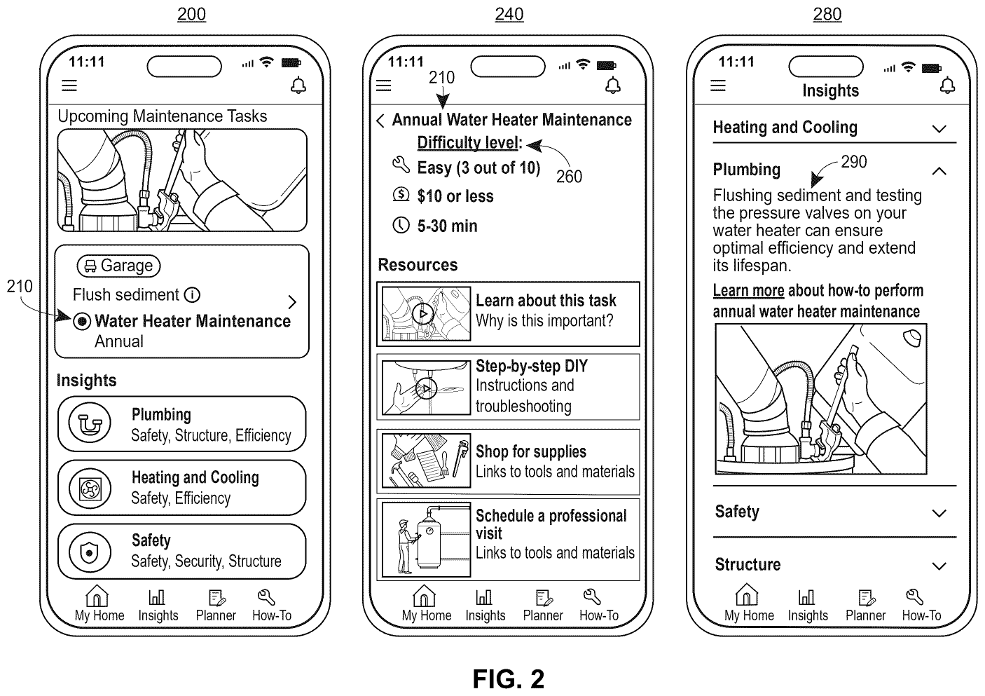

FIG. 2 depicts exemplary screens for presenting an insight. More specifically, FIG. 2 depicts exemplary screens for presenting an insight for water heater maintenance. That is, exemplary screens 200, 240 depict the insight 210 for water heater maintenance (e.g., draining or flushing a hot water heater). Exemplary screen 280 depicts an explanation 290 of benefits of performing the insight.

### Exemplary Computer-implemented Method for Determining an Insight to Improve a Property

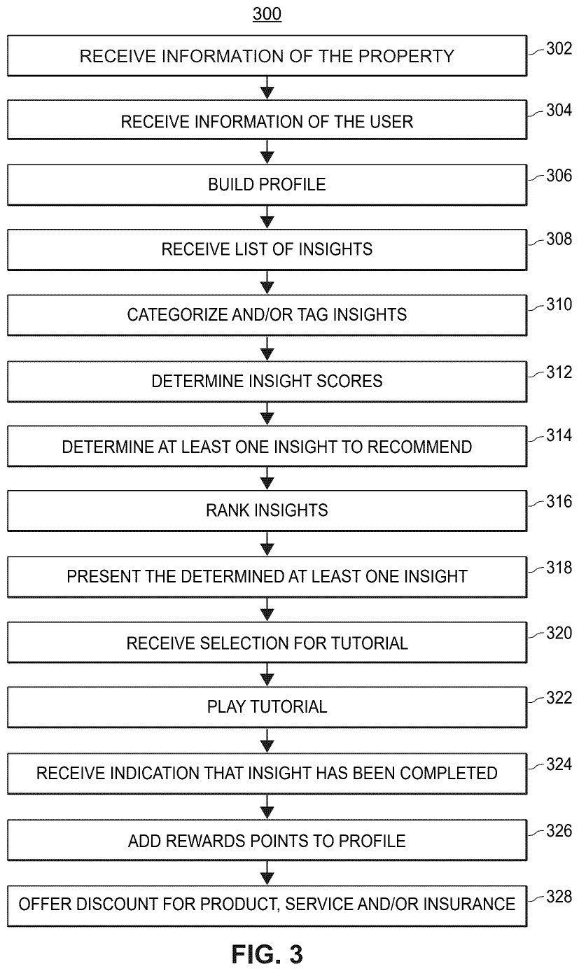

FIG. 3 illustrates a flow diagram representing an exemplary computer-implemented method or implementation 300 for determining an insight to improve a property. The exemplary method 300 may be implemented by a computing environment 100, for example, including the computing device 102, the user device 152, 162, 172, and/or any suitable device including those discussed elsewhere herein, such as one or more local or remote processors, transceivers, memory units, sensors, mobile devices, unmanned aerial vehicles (e.g., drones), etc.

Although the following discussion refers to the exemplary method or implementation 300 as being performed by the one or more processors 120, it should be understood that any or all of the blocks may be alternatively or additionally performed by any other suitable component as well (e.g., one or more processors of the user device 152, 162, 172, etc.).

The exemplary method or implementation 300 may begin at block 302 when the one or more processors 120 receive information of the property 150, 160, 170. Examples of the information of the property include: (i) plumbing information of the property 150, 160, 170; (ii) heating, venting, and cooling (HVAC) information of the property 150, 160, 170; (iii) a geographic location of the property 150, 160, 170; (iv) appliance information of the property 150, 160, 170; (v) device information of the property 150, 160, 170 (e.g., a list of devices on the property, such as smart smoke detectors, smart thermostats, etc.); (vi) if the property has a basement; (vii) if the property has hose bib(s); etc.

The information of the property may be received from any suitable source, such as the user device 152, 162, 172, the external database 180, the internal database 118, etc. In some examples, the user 151, 161, 171 (e.g., the property owner of the property 150, 160, 170, etc.) enters answers to questions (e.g., enters the information of the property in the form of answers) into the user device 152, 162, 172, which are sent to the computing device 102. The answers may be entered in any suitable form.

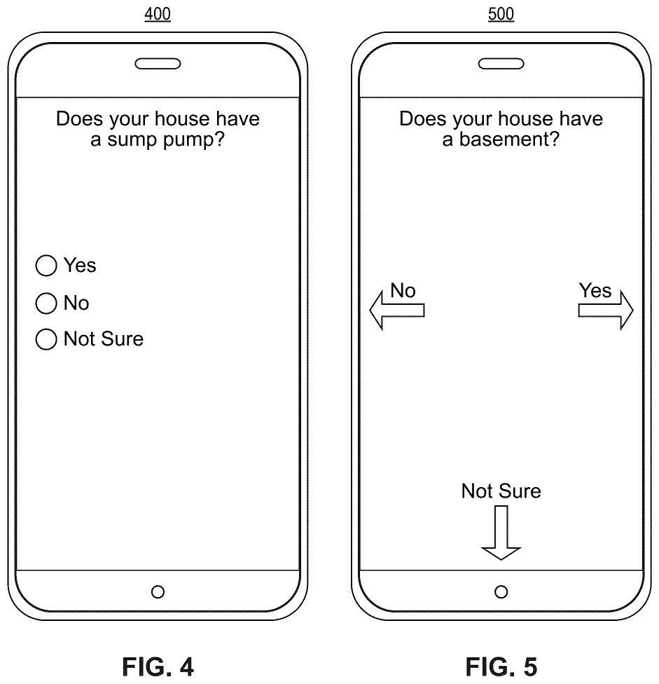

To this end, FIG. 4 depicts exemplary screen 400 (e.g., displayed on user device 152, 162, 172) allowing entry of an answer in the form of multiple choice entry. FIG. 5 depicts exemplary screen 500 (e.g., displayed on user device 152, 162, 172) allowing entry of an answer in the form of swipe entry.

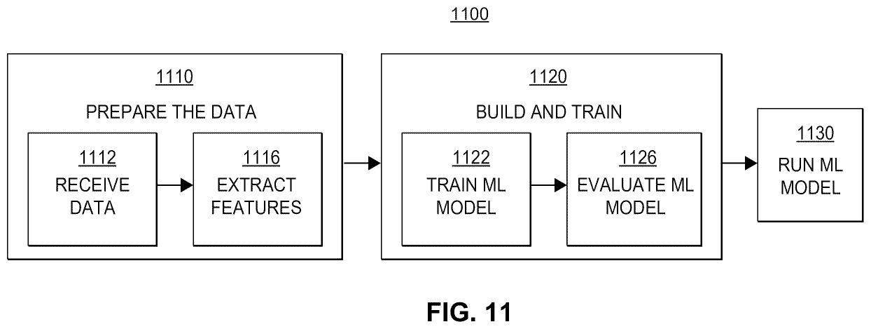

In some embodiments, the questions are determined via AI and/or ML. For instance, an AI and/or ML algorithm (e.g., a question determining AI and/or ML algorithm) may determine questions to ask the user 151. For instance, the AI and/or ML algorithm may determine to ask a person questions relevant to a geographic area (e.g., ask a person in California questions about a property's fire safety; ask questions to a person in Illinois about if the house has a basement and/or sump pump; etc.). Such an AI and/or ML algorithm may be trained in accordance with the principles of FIG. 11.

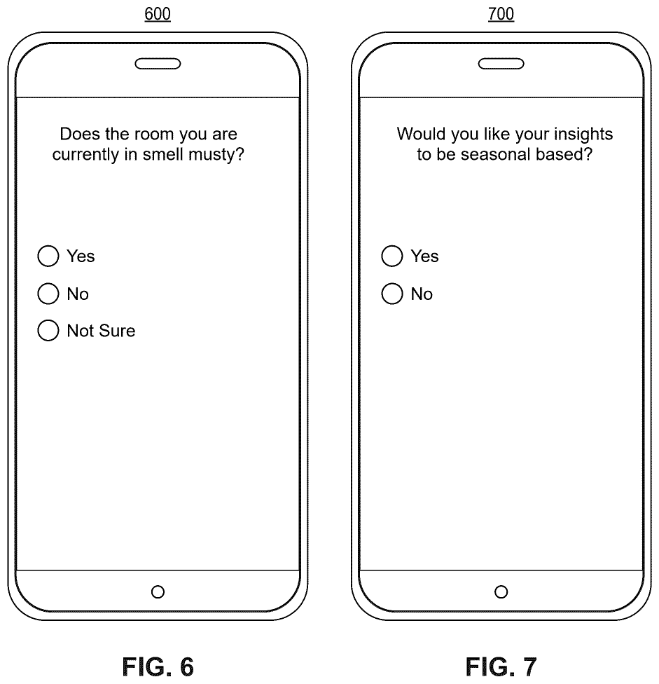

Additionally or alternatively, the information of the property may include an indication of a: (i) sight, (ii) sound, and/or (iii) smell. To this end, FIG. 6 depicts exemplary screen 600 (e.g., displayed on user device 152, 162, 172) allowing entry of an indication of a smell, which in the illustrated example, is a musty smell. Additionally or alternatively, the user 151 may enter indication(s) of the sight and/or sound in the form of an answer to a question.

Additionally or alternatively, the user 151 may upload imagery data (e.g., image(s), video, etc.) and/or recordings, and the one or more processors 120 may analyze the uploaded data to determine the indication(s).

At block 304, the one or more processors 120 may receive information of the user 151, 161, 171. In some examples, the information of the user 151, 161, 171 includes one or more preferences of the user 151, 161, 171. FIG. 7 depicts exemplary screen 700 (e.g., displayed on user device 152, 162, 172) allowing entry of a seasonal preference. As will be seen, indication of a seasonal preference will increase the likelihood of the system recommending an insight corresponding to a season at an appropriate time (e.g., recommending draining a pipe that may freeze before the winter begins).

Another example of a preference is a preference for insights corresponding to a difficulty level. For instance, in the example of screen 240, the insight has a difficulty level 260 of easy. As will be seen, a user preference for easy insights increases the likelihood that that the system will recommend an easy insight.

At block 306, the one or more processors 120 may build a profile (e.g., a profile of the property 150, 160, 170 and/or the user 151, 161, 171). The profile may be built based upon the information of the property and/or the information of a user. The profile may be stored in the memory 122, the external database 180, the internal database 118, any of the user devices 151, 161, 171, etc.

The profile may include any or all of the information of the property and/or the information of a user. The profile may further include identifying information of the user 151, 161, 171 (e.g., name, address, gender, age, demographic, etc.).

In some examples, the indication(s) of the: (i) sight, (ii) sound, and/or (iii) smell (e.g., received at block 302) is also added to the profile.

At block 308, the one or more processors 120 may receive a list of insights. The insights may be received from any suitable source, such as the memory 122, the external database 180, the internal database 118, any of the user devices 151, 161, 171, etc. Examples of the insights include:
locating a water main valve and learning how to shut it off;
checking a smoke detector battery;
locating gas main and learning how to shut it off;
changing a heating, venting, and cooling (HVAC) filter;
performing water heater maintenance (e.g., draining or flushing a hot water heater);
cleaning faucets and/or showerheads to remove mineral deposits;
checking toilets for running water and/or leaks around seal at base;
locating a circuit breaker box;
inspecting and/or cleaning dryer vents;
searching foundation and/or walls for water leaks or damage;
troubleshooting common pest control issues (e.g., rodents, roaches, ants, etc.);
servicing and/or inspecting air conditioner;
checking for drainage issues (e.g., standing water around the house, etc.);
checking any or all door and window seals to ensure tight seals with no gaps;
cleaning garbage disposal(s);
inspecting and/or unclogging sink, tub and/or shower drains;
cleaning HVAC ducts;
testing carbon monoxide detectors and/or replacing batteries;
installing water sensors in areas at risk for leaks;
creating a home inventory list;
placing extensions at gutter downspout bases to direct water away from foundation;
checking washing machine hoses for fraying, cracks or leaks;
installing a water monitor/leak detector to detect small leaks (e.g., before they become a larger problem);
inspecting plumbing fixtures;
vacuuming HVAC vents and registers;
checking window and door locks for optimal security;
learning about home systems and appliances and their typical lifespan;
checking caulking at doors and windows;
inspecting roof;
cleaning washing machine with a washing machine cleaning solution;
checking for recalls on your appliances;
recording important home information like paint colors and finishes;
reversing ceiling fan blades to circulate air downwards;
cleaning dishwasher screen filter;
inspecting the siding and trim for damage or deterioration;
cleaning front porch and back deck;
checking gauge and expiration on fire extinguishers;
having energy audit to discover drafts, air leaks and energy inefficiencies;
cleaning and/or lubricating window tracks and/or cranking out window operators;
checking to ensure fireplace damper is closed;
checking and recaulking tile and/or countertops (e.g., on sinks, showers, and bathtubs, etc.);
checking for water stains under eaves;
increasing air conditioning thermostat temperature when away from property;
fertilizing lawn and/or mulch garden beds;
cleaning any or all windows;
unplugging appliances and shutoff water supply valves to toilets and/or washing machine (e.g., if leaving property for an extended period);
checking the hose between the wall and the refrigerator to determine if it is pinched or stressed, and/or searching hose for signs of leaking, wear and/or tear;
adding an air quality monitor;
adding a security system;
checking fencing for gaps or breaks;
utilizing a dehumidifier to keep damp areas free of mold and mildew in warmer months;
testing and/or troubleshooting for optimal internet connection strength;
testing for radon;
having sprinkler/irrigation system serviced;
installing and/or cleaning window screens and/or checking for holes;
filling cracks and/or sealing asphalt or concrete in walkways and/or driveways;
installing low-flow shower heads and toilets to reduce water waste;
installing exterior lighting;
adding an electrical monitoring device;
cleaning refrigerator (e.g., inside and/or outside);
for coil-back refrigerator, vacuuming the coils to increase efficiency;
setting sprinklers for very early morning (e.g., before sunrise);
restocking cleaning and maintenance supplies;
installing deadbolts on exterior doors;
having fireplace inspected;
checking driveway and/or walkways to determine if pressure washing is needed, and/or performing pressure washing if needed;
examining and/or testing sump pump;
installing a whole home automatic water shutoff valve;
checking attic insulation for fullness and/or adding or replacing as needed;
testing Ground Fault Circuit Interrupter (GFCI) outlets;
checking yard for soil erosion;
checking internet service providers and offers in your area;
checking landscaping for hazardous trees and tree limbs;
removing insulation from outdoor faucets;
cleaning fireplace;
testing well water (e.g., every 6 months, etc.);
planting flowers and shrubs in front to boost curb appeal;
testing sprinkler system and inspecting for breaks;
installing sump pump;
scheduling a security audit of property to learn about device and service options tailored to specific needs of the property; and/or
switching to renewable energy source(s).

At block 310, the one or more processors 120 may categorize and/or tag the any or all of the insights from the list of insights. For example, the insights may be categorized based upon a room of the house. For instance, checking and recaulking tile may be categorized to bathrooms. In this way a user will later be able to view insights for a specific room or type of room.

Additionally or alternatively to the categorization, insights may be tagged. Advantageously, multiple tags may be placed on an insight. For instance, an insight to check and/or recalk tile may be applied a tag for bathrooms generally and also for a specific bathroom (e.g., the bathroom on the second floor, north side, etc.).

Additionally or alternatively, insights may be categorized and/or tagged according to a type of insight, such as a type corresponding to a home subscore (e.g., pluming, HVAC, safety, structural, environmental, etc.). FIG. 9 depicts an exemplary screen 900 listing plumbing insights 910, 920, and further listing options to view categories and/or tags 930 (e.g., safety, plumbing, HVAC, structural, etc.).

Additionally or alternatively, insights may be categorized and/or tagged based upon urgency. For example, there may be categories/tags for highly urgent (e.g., snowstorm is predicted within 24 hours so pipes at risk for freezing should be drained), moderately urgent (e.g., HVAC filter should be replaced within two weeks, etc.), not urgent (e.g., HVAC filter should be replaced within a month, etc.), etc.

At block 312, the one or more processors 120 may determine insight scores for any or all of the insights on the list of insights. In some examples, the insight score is a number (e.g., on a scale of 0-10, 0-100, 0-1000, etc.). Additionally or alternatively, the score may correspond to a level (e.g., level A/B/C, etc.).

In some examples, the insight score is based wholly or partially upon a difficulty score of the insight, such as difficulty score 260 illustrated in the example of FIG. 2. In some examples, the difficulty score is manually assigned by a human expert. In some examples, if the user has indicated a preference for a particular difficulty level, the insight score is modified accordingly; for instance, if the user has indicated a preference for easy insights, the insight score may be increased for insights with an easy difficulty level.

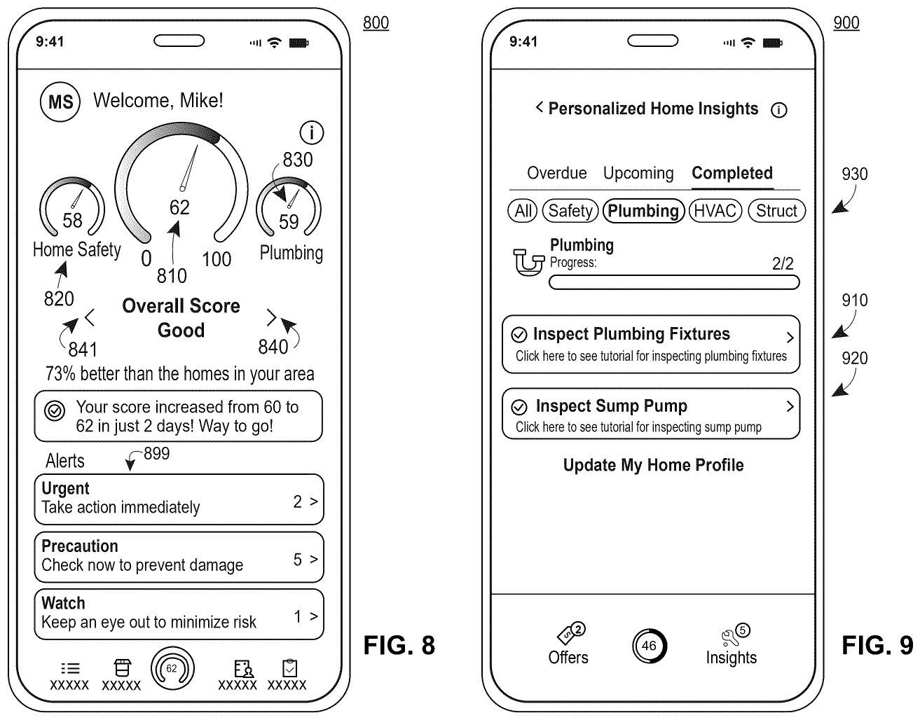

Additionally or alternatively, the insight score(s) may be determined wholly or partially based upon home score(s) (e.g., determined by home score generator 128). In some examples, the home score may include or be based upon subscores, such as a safety subscore (e.g., safety with regard to fire, weather hazards, crime, etc.), a structural subscore, a plumbing subscore, a heating, ventilation, and air conditioning (HVAC) subscore, etc. In this regard, FIG. 8 depicts a further exemplary screen 800 displaying an overall home score 810, a home safety subscore 820, and a fire protection subscore 830. Furthermore, arrows 840, 841 allow the user to toggle between the home scores and/or subscores. For example, pressing the arrow 840 may display the home safety subscore in the center of the screen, etc.

Additionally or alternatively, the insight score(s) may be determined wholly or partially based upon any other information included in the information of the property (e.g., received at block 302) and/or information of the user (e.g., received at block 304). For example, if a home already has a large number of smoke detectors installed, the insight score for installing a smoke detector may be reduced; whereas, if the home has only a small number of smoke detectors installed, the insight score may be increased.

In another example, if a house does not have a basement, an insight score for installing a sump pump may be reduced by a predetermined amount, or reduced to zero.

In yet another example, if the user profile indicates a preference for seasonal insights, the insight score for draining a pipe before winter may be increased.

In some examples, the insight score may be determined by averaging the difficulty score and the home score. In some examples, the insight score may be determined wholly or partially by taking a weighted average of the difficulty score and the home score (e.g., by weighting the difficulty score more than the home score, or vice versa).

In some examples, the insight score may be determined wholly or partially based upon different weights and/or scores assigned to different tags and/or categories. For example, an insight categorized as safety have more weight than an HVAC or plumbing insight; thus, in this example, a tag of safety would increase an insight score more than a tag of HVAC or plumbing.

In some examples, the insight score may be determined wholly or partially based upon devices in the home 150. For example, insight to check GFCI outlets may be given a lower insight score for a home has a device that detects electrical fires than to a home that does not have a device that detects electrical fires.

In some examples, the insight score may be determined wholly or partially based upon geographic location of the home 150. For example, an insight to water a house foundation to prevent cracks during the summer may be given higher score in Texas than Minnesota. In another example, draining a pipe to prevent freezing may be given more points in Wisconsin than Alabama.

In some examples, the insight score may be determined wholly or partially based upon weather data. For example, if weather data predicts that a winter will be particularly harsh or predicts that a snowstorm is approaching, the insight score for draining pipes at risk for freezing may be increased. Further regarding the weather data, alerts (e.g., as in the example 899 of FIG. 8) may be generated. For example, if a snowstorm is imminent, an alert to perform an insight of draining pipes at risk for freezing may be generated and/or displayed. In some examples, the alert may include a map indicating a mandatory evacuation area; such an alert may only be pushed out to homes in the relevant geographic area (e.g., determined via zip code, etc.). For less urgent matters, in some embodiments, notifications (rather than alerts) may be generated and/or displayed to present the insight.

In some examples, the insight score may be determined wholly or partially based upon the indicated (i) sight, (ii) sound, and/or (iii) smell. For example, an indication of a musty smell may increase the insight score of an insight to check for water leaks and/or an insight to inspect for mold.

At block 314, the one or more processors 120 may determine at least one insight to recommend (e.g., from the received list of insights). In some examples, the recommended insight(s) are determined to be the insight(s) with the highest (or lowest) respective insight score(s).

At block 316, the one or more processors 120 may rank (e.g., prioritize, etc.) any or all of the insights from the list of insights. In some examples, only the recommended insights are ranked.

In some examples, the insights are ranked based upon: (i) the insight scores, (ii) the difficulty scores, (iii) urgency, and/or (iv) a change that completing the insight would make to any of the home scores or subscores.

At block 318, the one or more processors 120 may present (e.g., cause to be presented) the recommended insight(s). For instance, the insight(s) may be presented in visual form (e.g., on a display of the user device 152, 162, 172, etc.), and/or auditory form (e.g., via the user device 152, 162, 172, etc.). The insights may be presented in the ranked order.

Additionally or alternatively, the insights may be presented according to the categorizations and/or tags. In one example, a user 151 may walk through the home 150, and insights are presented according to the room that the user 151 is in. For instance, the user device 152 may determine which room that the user 151 is in (e.g., via a global positioning satellite (GPS) device), and the insights corresponding to the determined room may be presented. In other examples, the user 151 selects, via the app, to see all insights corresponding to a particular type of room (e.g., all insights corresponding to kitchens, bathrooms, bedrooms, basements, etc.). Such insights may be presented along with an indication of the type of room (e.g., a label on the screen saying “basement”).

Additionally or alternatively, the insights may be presented according to the urgency category and/or tag. For instance, a user 151 may request to see only urgent insights.

At block 320, the one or more processors 120 may receive a selection for a tutorial. For example, the selection may be received in response to a user pressing button 910 or 920 of FIG. 9.

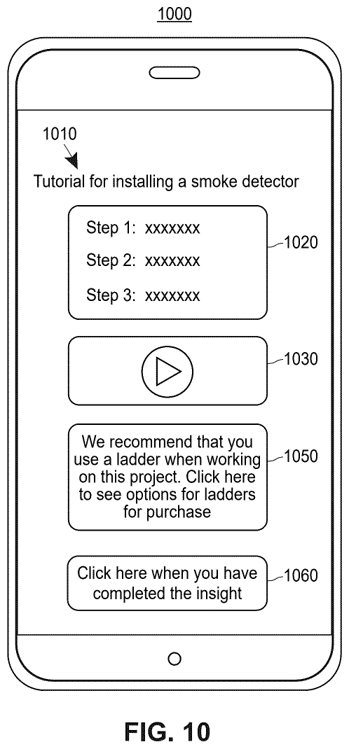

At block 322, the one or more processors 120 may present a tutorial in response to receiving the selection. FIG. 10 depicts exemplary screen 1000 including tutorial 1010 explaining how to complete insight 1020. The exemplary tutorial 1010 includes both text 1020 and video 1030. The exemplary tutorial 1010 may further include recommendation for a tool 1050 to use while completing the insight.

At block 324, the one or more processors 120 may receive an indication that the insight has been completed. For example, the indication may be received in response to the user clicking button 1060 on exemplary screen 1000.

Additionally or alternatively, the indication may be received from a contractor device of contractor 199. The contractor device may be any suitable device, such as a computer, a mobile device, a smartphone, a laptop, a phablet, a chatbot or voice bot, etc. The contractor device may include one or more display devices, one or more processors, one or more memories, etc. For instance, if the insight is to have an HVAC inspection, an HVAC repairperson 199 may send the indication when she completes the inspection.

In some examples, advantageously for additional security, the one or more processors 120 may require verification that the insight has been completed. For example, for verification, following the user 151 clicking button 1060, the user may be required so send imagery data proving that the insight has been completed (e.g., a picture of an installed smoke detector, etc.).

Additionally or alternatively, the verification may occur via tax records and/or permits (e.g., person takes out permit to perform construction to complete an insight). Such verification may come from an external source, for example, the external database 180, the contractor 199, etc.

At block 326, the one or more processors 120 may, in response to completion of the insight, add rewards points to the profile. For example, more rewards point(s) may be added to the profile for completion of a difficult insight; and less rewards point(s) may be added for completion of an easy insight. Furthermore, the home score and/or any of the subscores may be recalculated based upon completion of the insight.

At block 328, the one or more processors 120 may present a discount for a product, service and/or insurance. In some examples, the discount is presented on a display of the user device 152, 162, 172. For example, a discount may be offered on homeowners insurance. In another example, a discount may be offered at a store that sells products that may be used to complete future insights (e.g., a store that sells ladders, etc.). In yet another example, a discount may be offered on a service to complete an insight (e.g., a discount on an HVAC inspection, etc.). In some examples, the discount is based upon a total number of rewards points in the profile (e.g., a larger discount offered to users with more points in their profile).

### Exemplary AI and/or ML Techniques for Determining an Insight Score

In some embodiments, AI and/or ML algorithm(s) and/or model(s) may be used to partially or wholly determine insight score(s), home score(s), and/or questions to ask the user. Although the following discussion refers to an ML algorithm, it should be appreciated that it applies equally to ML and/or AI algorithms and/or models.

FIG. 11 is a block diagram of an exemplary machine learning modeling method 1100 for training and evaluating a ML algorithm (e.g., an insight score determining ML algorithm, etc.), in accordance with various embodiments. In some embodiments, the model “learns” an algorithm capable of performing the desired function, such as determining an insight score. It should be understood that the principles of FIG. 11 may apply to any machine learning algorithm discussed herein.

Although the following discussion refers to the blocks of FIG. 11 as being performed by the one or more processors 120, it should be appreciated that the blocks of FIG. 11 may be performed by any suitable component or combinations of components (e.g., one or more processors of any of the user devices 152, 162, 172, etc.).

At a high level, the machine learning modeling method 1100 includes a block 1110 to prepare the data, a block 1120 to build and train the model, and a block 1130 to run the model.

Block 1110 may include sub-blocks 1112 and 1116. At block 1112, the one or more processors 120 may receive the historical information to train the machine learning algorithm. In some examples, the historical information comprises: (i) inputs to the machine learning model (e.g., also referred to as independent variables, or explanatory variables), and/or (ii) outputs of the machine learning model (e.g., also referred to as dependent variables, or response variables). In some such examples, the dependent variables are the insights scores that the ML algorithm is trained to determine; and the independent variables (e.g., historical insights, historical profiles, etc.) are used to determine the dependent variables. Put another way, the independent variables may have an impact on the dependent variables; and the ML algorithms may be trained to find this impact. Therefore, when using a trained ML algorithm to determine an insight score, information corresponding to the historical information that the ML was trained on may be routed into the ML algorithm to determine the insight score. For example, insights (e.g., from the list of insights received at block 308), profile(s), etc., may be input into the trained ML algorithm to determine the insight score.

More specifically, for the historical information used to train the insight determining ML algorithm, examples of the independent variables may include historical: historical insights, profiles, etc. An example of the dependent variable is historical insight scores.

The historical information may be received from any suitable source. Examples of sources that any of the historical information may be received from include: memory 122, internal database 118, the external database 180, the smart devices 153, 163, 173, etc. It should be appreciated that the historical information may be received from combinations of these sources as well.

Block 1120 may include sub-blocks 1122 and 1126. At block 1122, the machine learning (ML) model is trained (e.g. based upon the data received from block 1110). In some embodiments where associated information is included in the historical information, the ML model “learns” an algorithm capable of calculating or predicting the target feature values (e.g., determining an insight score, etc.) given the predictor feature values.

At block 1126, the one or more processors 120 may evaluate the machine learning model, and determine whether or not the machine learning model is ready for deployment.

Further regarding block 1126, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information discussed above), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

Moreover, it should be appreciated the ML algorithm may be any kind of ML algorithm (e.g., neural network, convolutional neural network, deep learning algorithm, etc.).

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Exemplary Home Score Determination

As mentioned above, some embodiments may include determining a home score and/or subscores. Examples of the subscores include a safety subscore (e.g., safety with regard to fire, weather hazards, crime, etc.), a structural subscore, a plumbing subscore, a HVAC subscore, a home automation subscore, etc. Such a determination may be done at any point with respect to the exemplary computer-implemented method 300 of FIG. 3.

The home score(s) may be determined by any suitable technique. In some examples, the home scores may be determined without the use of machine learning. For example, in some embodiments, the subscores may be determined by determining attribute(s) for each subscore. Subsequently, the overall home score may be determined by combining the subscore (e.g., by taking an average or weighted average of the subscores).

For example, in some variations, the home safety subscore may be determined based upon one or more home safety attributes; the fire protection subscore may be determined based upon one or more fire protection attributes; the sustainability subscore may be determined based upon one or more sustainability attributes; and/or the home automation subscore may be determined based upon one or more home automation attributes.

Any or all of the attributes may be valued (e.g., measured, etc.) in the form of a “grade. ” In this regard, such attributes may be “categorical” attributes. In some examples, the grades may be letter grades of A through F. Further, the grades may be assigned numerical scores.

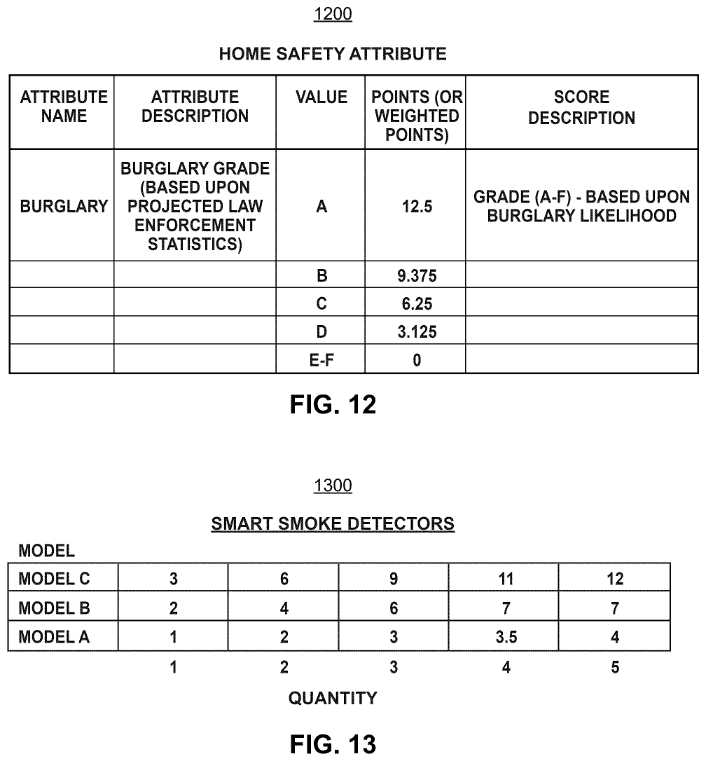

By way of exemplary illustration, FIG. 12 shows an exemplary table 1200 indicating information of an exemplary home safety attribute. The attribute may have a name, which, in the illustrated example, is a burglary attribute. The exemplary attribute may be assigned a grade (e.g., a value), such as a grade of A through F. The grade/value may further be assigned points and/or weighted points. For instance, in the illustrated example, a grade of A may be assigned 12.5 points; a grade of B may be assigned 9.375 points; a grade of C may be assigned 6.25 points; a grade of D assigned 3.125 points; and/or a grade of E or F assigned 0 points.

In some embodiments, when values are missing (e.g., NaN, etc.), they may be filled in with a neutral value. For instance, with respect to the example of FIG. 12, if any of the values corresponding to attributes with a grade (A-F) are missing, they may be filled in with a value of C. For example, if the burglary value is missing, it may be filled in with a value of C, and thus receive points or weighted points of 6.25.

In some implementations, the grades and/or categorical values may be assigned by a vendor evaluating the home 150. The assigned grades and/or categorical values may then be stored in a database, and/or sent directly to any other component in FIG. 1.

Additionally or alternatively, individual devices (e.g., as indicated in the profile, etc.) may affect a home score(s) by a specific amount (e.g., adding an electrical meter improves a sustainability subscore by 3 points; adding a smart water meter improves a sustainability subscore by 2 points; adding a smart smoke detector improves a home automation subscore by 1 point; etc.). In addition, in some embodiments, each device affects the home score incrementally (e.g., each smart smoke detector added adds one point to the fire protection subscore, etc.). However, in some such embodiments, there is a maximum number of devices that may continue to improve the home score(s) (e.g., the first 5 smoke detectors each improve the fire protection subscore by 1 point, but the sixth does not improve the home score). In some certain embodiments, the improvements are phased out (e.g., the first four smoke detectors each improve the fire protection subscore by 1 point, the next 3 smoke detectors improve the fire protection subscore by half a point, and the subsequent smoke detectors do not improve the fire protection subscore). Furthermore, different models of a device may have different impacts on the home score(s) (e.g., a basic model smart main water shut off valve improves a home automation subscore by 2 points, and a more advanced model improves the home automation subscore by 4 points). As such, the home score(s) may be affected by both the model and the quantity of the device.

To this end, the attribute may also comprise a matrix of devices. For example, for any of the subscores, there may be an attribute including device matrixes for particular devices. For instance, FIG. 13 depicts exemplary matrix 1300 of smart smoke detectors indicating points that the smart smoke detectors increase the home automation subscore by. The exemplary matrix 1300 depicts both model and quantity of the device, with the numbers in the matrix indicating how the devices affect the home automation subscore. For example, as illustrated, a home automation subscore for a home with one model A smoke detector would get 1 point for the model A smoke detector. In another illustrated example, a home automation subscore for a home with three model C smoke detectors would get 9 points for the smoke detectors.

Additionally or alternatively, the one or more processors 120 may determine at least one of an overall home score, a home safety subscore, a fire protection subscore, a sustainability subscore, and/or a home automation subscore for a home via machine learning (e.g., trained as described with respect to FIG. 11).

### Additional Exemplary Embodiments

In one aspect, a computer-implemented method for determining an insight to improve a property may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) building, via one or more processors, a profile based upon information of the property and/or information of a user; (2) receiving, via one or more processors, a list of insights; (3) determining, via the one or more processors, based upon the profile, insight scores for respective insights of the list of insights; (4) determining, via the one or more processors, at least one insight to recommend based upon the insight scores; and/or (5) presenting, via the one or more processors, to the user, the determined at least one insight. The method may include additional, fewer, or alternate actions, including those discussed elsewhere herein.

In some embodiments, the building the profile may include building the profile based upon the information of the property, and/or the information of the property may include: plumbing information of the property; heating, venting, and cooling (HVAC) information of the property; a geographic location of the property; appliance information of the property; and/or device information of the property.

In some embodiments, the building the profile may include building the profile based upon the information of the user, and/or the information of the user includes: a preference for seasonal insights; and/or a preference for insights corresponding to a difficulty level.

In certain embodiments, the building the profile may include: presenting, via the one or more processors, questions to the user; receiving, via the one or more processors, answers to the questions; and/or building, via the one or more processors, based upon the answers, the profile.

In various embodiments, the at least one insight may include at least two insights, and/or the computer-implemented method further includes: ranking, via the one or more processors, the at least two insights based upon the insight scores for respective insights of the at least two insights; and/or wherein the presenting, via the one or more processors, to the user, the determined at least one insight includes presenting the respective insights of the at least two insights according to the ranking.

In some embodiments, the at least one insight may include at least two insights, and/or the computer-implemented method further may include: categorizing, via the one or more processors, into at least two categories, the at least two insights based upon the insight scores for respective insights of the at least two insights; and/or wherein the presenting, via the one or more processors, to the user, the determined at least one insight includes presenting the respective insights of the at least two insights according to the categorization.

In certain embodiments, the list of insights may include at least one insight for: locating a water main valve and/or learning how-to shut off; checking a smoke detector battery; locating gas main and/or learning how to shut off; changing a heating, venting, and cooling (HVAC) filter; performing water heater maintenance; cleaning faucets and/or showerheads to remove mineral deposits; checking toilets for running water and/or leaks around seal at base; locating a circuit breaker box; inspecting and/or cleaning dryer vents; and/or searching foundation and/or walls for water leaks or damage.

In some embodiments, the at least one insight may include: a first insight corresponding to a first room of the property, and/or a second insight corresponding to a second room of the property; and/or the presenting includes presenting, via the one or more processors: (i) the first insight along with an indication of the first room, and/or (ii) the second insight along with an indication of the second room.

In various embodiments, the computer-implemented method further may include: receiving, via the one or more processors, from the user, a selection for a tutorial; in response to the receiving the selection, retrieving, via the one or more processors, a video tutorial corresponding to the at least one insight; and/or playing, via the one or more processors, the video tutorial on a display device.

In some embodiments, the computer-implemented method further may include: receiving, via the one or more processors, from the user, an indication of a: (i) sight, (ii) sound, and/or (iii) smell; and/or adding, via the one or more processors, the indication to the profile; wherein the insight scores are determined further based upon the indication.

In certain embodiments, the computer-implemented method further may include: (i) receiving, via the one or more processors, an indication that the determined at least one insight has been completed; (ii) adding, via the one or more processors, rewards points to the profile based upon the insight score of the completed insight; (iii) determining, via the one or more processors, a discount for a product based upon a total number of rewards points in the profile; and/or (iv) presenting, via the one or more processors, the discount to the user.

In some embodiments, the computer-implemented method further may include: training, via the one or more processors, an artificial intelligence (AI) algorithm based upon: (i) historical independent variables including (a) historical insights, and/or (b) historical profiles; and/or (ii) historical dependent variables including historical insight scores; wherein the determining the insight scores is accomplished by inputting the list of insights and/or the profile into the trained AI algorithm.

In another aspect, a computer device for determining an insight to improve a property may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) build a profile based upon information of the property and/or information of a user; (2) receive a list of insights; (3) determine, based upon the profile, insight scores for respective insights of the list of insights; (4) determine at least one insight to recommend based upon the insight scores; and/or (5) present, to the user, the determined at least one insight. The computer device may include additional, less, or alternate functionality, including that discussed elsewhere herein.

In some embodiments, the one or more processors are configured to build the profile based upon the information of the property, and/or the information of the property includes: plumbing information of the property; heating, venting, and cooling (HVAC) information of the property; a geographic location of the property; appliance information of the property; and/or device information of the property.

In certain embodiments, the one or more processors are configured to build the profile based upon the information of the user, and/or the information of the user includes: a preference for seasonal insights; and/or a preference for insights corresponding to a difficulty level.

In various embodiments, the one or more processors are configured to present the determined at least one insight by causing a display to display the determined at least one insight.

In yet another aspect, a computer system for determining an insight to improve a property may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) build a profile based upon information of the property and/or information of a user; (2) receive a list of insights; (3) determine, based upon the profile, insight scores for respective insights of the list of insights; (4) determine at least one insight to recommend based upon the insight scores; and/or (5) present, to the user, the determined at least one insight. The computer system may include additional, less, or alternate functionality, including that discussed elsewhere herein.

In some embodiments, the one or more non-transitory memories having stored thereon computer-executable instructions that, when executed by the one or more processors, cause the one or more processors to build the profile further based upon the information of the property, and/or wherein the information of the property includes: plumbing information of the property; heating, venting, and cooling (HVAC) information of the property; a geographic location of the property; appliance information of the property; and/or device information of the property.

In certain embodiments, the one or more non-transitory memories having stored thereon computer-executable instructions that, when executed by the one or more processors, cause the one or more processors to further build the profile based upon the information of the user, and/or wherein the information of the user includes: a preference for seasonal insights; and/or a preference for insights corresponding to a difficulty level.

In various embodiments, the computer system further may include a display device; and/or wherein the one or more non-transitory memories having stored thereon computer-executable instructions that, when executed by the one or more processors, cause the one or more processors to present the determined at least one insight by displaying, on the display device, the determined at least one insight.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_____’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for determining an insight to improve a property, the computer-implemented method comprising:
building, via one or more processors, a profile based upon information of the property and/or information of a user;
receiving, via one or more processors, a list of insights;
determining, via the one or more processors, based upon the profile, insight scores for respective insights of the list of insights;
determining, via the one or more processors, at least one insight to recommend based upon the insight scores; and
presenting, via the one or more processors, to the user, the determined at least one insight.

2. The computer-implemented method of claim 1, wherein the building the profile includes building the profile based upon the information of the property, and the information of the property includes:
plumbing information of the property;
heating, venting, and cooling (HVAC) information of the property;
a geographic location of the property;
appliance information of the property; and/or
device information of the property.

3. The computer-implemented method of claim 1, wherein the building the profile includes building the profile based upon the information of the user, and the information of the user includes:
a preference for seasonal insights; and/or
a preference for insights corresponding to a difficulty level.

4. The computer-implemented method of claim 1, wherein the building the profile includes:
presenting, via the one or more processors, questions to the user;
receiving, via the one or more processors, answers to the questions; and
building, via the one or more processors, based upon the answers, the profile.

5. The computer-implemented method of claim 1, wherein the at least one insight includes at least two insights, and the computer-implemented method further includes:
ranking, via the one or more processors, the at least two insights based upon the insight scores for respective insights of the at least two insights;
wherein the presenting includes presenting, via the one or more processors, the respective insights of the at least two insights according to the ranking.

6. The computer-implemented method of claim 1, wherein the at least one insight includes at least two insights, and the computer-implemented method further includes:
categorizing, via the one or more processors, into at least two categories, the at least two insights;
wherein the presenting includes presenting, via the one or more processors, the respective insights of the at least two insights according to the categorization.

7. The computer-implemented method of claim 1, wherein the list of insights includes at least one insight for:
locating a water main valve and learning how to shut off the main water valve;
checking a smoke detector battery;
locating gas main and learning how to shut off the gas main;
changing a heating, venting, and cooling (HVAC) filter;
performing water heater maintenance;
cleaning faucets and/or showerheads to remove mineral deposits;
checking toilets for running water and/or leaks around seal at base;
locating a circuit breaker box;
inspecting and/or cleaning dryer vents; and/or
searching foundation and/or walls for water leaks or damage.

8. The computer-implemented method of claim 1, wherein:
the at least one insight includes: a first insight corresponding to a first room of the property, and a second insight corresponding to a second room of the property; and
the presenting includes presenting, via the one or more processors: (i) the first insight along with an indication of the first room, and (ii) the second insight along with an indication of the second room.

9. The computer-implemented method of claim 1, further including:
receiving, via the one or more processors, from the user, a selection for a tutorial;
in response to the receiving the selection, retrieving, via the one or more processors, a video tutorial corresponding to the at least one insight; and
playing, via the one or more processors, the video tutorial on a display device.

10. The computer-implemented method of claim 1, further including:
receiving, via the one or more processors, from the user, an indication of a: (i) sight, (ii) sound, and/or (iii) smell; and
adding, via the one or more processors, the indication to the profile;
wherein the insight scores are determined further based upon the indication.

11. The computer-implemented method of claim 1, further including:
receiving, via the one or more processors, an indication that the determined at least one insight has been completed;
adding, via the one or more processors, rewards points to the profile based upon the insight score of the completed insight;
determining, via the one or more processors, a discount for a product based upon a total number of rewards points in the profile; and
presenting, via the one or more processors, the discount to the user.

12. The computer-implemented method of claim 1, further including:
training, via the one or more processors, an artificial intelligence (AI) algorithm based upon: (i) historical independent variables including (a) historical insights, and (b) historical profiles; and (ii) historical dependent variables including historical insight scores;
wherein the determining the insight scores is accomplished by inputting the list of insights and the profile into the trained AI algorithm.

13. A computer device for determining an insight to improve a property, the computer device comprising one or more processors configured to:
build a profile based upon information of the property and/or information of a user;
receive a list of insights;
determine, based upon the profile, insight scores for respective insights of the list of insights;
determine at least one insight to recommend based upon the insight scores; and
present, to the user, the determined at least one insight.

14. The computer device of claim 13, wherein the one or more processors are configured to build the profile based upon the information of the property, and the information of the property includes:
plumbing information of the property;
heating, venting, and cooling (HVAC) information of the property;
a geographic location of the property;
appliance information of the property; and/or
device information of the property.

15. The computer device of claim 13, wherein the one or more processors are configured to build the profile based upon the information of the user, and the information of the user includes:
a preference for seasonal insights; and/or
a preference for insights corresponding to a difficulty level.

16. The computer device of claim 13, wherein the one or more processors are configured to present the determined at least one insight by causing a display to display the determined at least one insight.

17. A computer system for determining an insight to improve a property, the computer system comprising:
one or more processors; and
one or more non-transitory memories, the one or more non-transitory memories having stored thereon computer-executable instructions that, when executed by the one or more processors, cause the one or more processors to:
build a profile based upon information of the property and/or information of a user;
receive a list of insights;
determine, based upon the profile, insight scores for respective insights of the list of insights;
determine at least one insight to recommend based upon the insight scores; and
present, to the user, the determined at least one insight.

18. The computer system of claim 17, the one or more non-transitory memories having stored thereon computer-executable instructions that, when executed by the one or more processors, cause the one or more processors to build the profile based upon the information of the property, and wherein the information of the property includes:
plumbing information of the property;
heating, venting, and cooling (HVAC) information of the property;
a geographic location of the property;
appliance information of the property; and/or
device information of the property.

19. The computer system of claim 17, the one or more non-transitory memories having stored thereon computer-executable instructions that, when executed by the one or more processors, cause the one or more processors to build the profile based upon the information of the user, and wherein the information of the user includes:
a preference for seasonal insights; and/or
a preference for insights corresponding to a difficulty level.

20. The computer system of claim 17, further comprising a display device;
wherein the one or more non-transitory memories having stored thereon computer-executable instructions that, when executed by the one or more processors, cause the one or more processors to present the determined at least one insight by displaying, on the display device, the determined at least one insight.
